(19) United States
(12) Patent Application Publication
(10) Pub. No.: US 2016/0021844 A1
(43) Pub. Date: Jan. 28, 2016

(54) LITTER BOX AERATOR

(71) Applicants: James Arnold PETERSON, Billerica, MA (US); Arnold George PETERSON, Billerica, MA (US)

(72) Inventors: James Arnold PETERSON, Billerica, MA (US); Arnold George PETERSON, Billerica, MA (US)

(21) Appl. No.: 14/808,722

(22) Filed: Jul. 24, 2015

Related U.S. Application Data
(60) Provisional application No. 62/029,433, filed on Jul. 26, 2014.

(51) Int. Cl. A01K 1/01; F04D 15/00; G05B 11/01

(52) U.S. Cl. CPC A01K 1/0107; G05B 11/01; F04D 15/00

(57) ABSTRACT

A litter box aerator apparatus is provided. The apparatus includes a base portion containing litter, a hood portion configured to enclose the litter box, a fan unit integrated within the hood portion, the fan unit including a fan, a filter and a screen, a sensor configured to determine when a domesticated animal is present in an internal space of the litter box, and a controller configured to activate the fan of the fan unit when the domesticated animal one of enters and exist the internal space of the litter box, and to deactivate the fan of the fan unit after a predetermined period of time.

### CROSS-REFERENCE TO RELATED APPLICATION(S)

This application claims the benefit under 35 U.S.C. § 119(e) of a provisional patent application filed on Jul. 26, 2014 and assigned Ser. No. 62/029,433, the entire disclosure of which is hereby incorporated by reference.

### TECHNICAL FIELD

The present invention generally relates to a litter box device. More specifically, the invention is a litter box aerator device.

### BACKGROUND

Household cats often utilize a litter box to dispose of their waste, which may leave behind a strong odor or stench. If the litter box is not emptied on a regular basis, a powerful odor may waft throughout the house or nearby areas.

Accordingly, an apparatus and method for removing odors from a litter box prior to, during and shortly after the litter box is used.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide an apparatus and method for removing odors from a litter box prior to, during and shortly after the litter box is used.

In accordance with an aspect of the present disclosure, a litter box aerator apparatus is provided. The apparatus includes a base portion containing litter, a hood portion configured to enclose the litter box, a fan unit integrated within the hood portion, the fan unit including a fan, a filter and a screen, a sensor configured to determine when a domesticated animal is present in an internal space of the litter box, and a controller configured to activate the fan of the fan unit when the domesticated animal one of enters and exist the internal space of the litter box, and to deactivate the fan of the fan unit after a predetermined period of time.

In accordance with another aspect of the present disclosure, a method of aerating a litter box is provided. The method includes determining, via a sensor, whether a domesticated animal has one of entered and exited an internal space of an enclosure of the litter box, activating a fan unit integrated into the enclosure of the litter box based upon the determination of whether the domesticated animal has one of entered and exited the internal space of an enclosure of the litter box, and deactivating the fan unit after a predetermined period of time from the activation of the fan unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a front view of a litter box according to an embodiment of the present disclosure;

FIG. 2 is a blown out view of a hood of a litter box with a fan unit integrated therein according to an embodiment of the present disclosure;

FIG. 3 is a side, front and top view of a hood of a litter box with a fan unit integrated therein according to an embodiment of the present disclosure;

FIG. 4 is a side and top view of a fan unit according to an embodiment of the present disclosure;

FIG. 5 is a top and side view of a filter according to an embodiment of the present disclosure;

FIG. 6 is a top and side view of a screen according to an embodiment of the present disclosure;

FIG. 7 is a flowchart illustrating a method according to an embodiment of the present disclosure; and

FIG. 8 illustrates a network environment including an electronic device according to various embodiments of the present disclosure.

Other aspects, advantages, and salient features of the disclosure will become apparent to those skilled in the art from the following detailed description, which, taken in conjunction with the annexed drawings, discloses various embodiments of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the various embodiments, a description of contents that are well known in the art to which this specification pertains and are not directly related to this specification is omitted in order to make the gist of this specification clearer by omitting an unnecessary description.

For the same reason, in the accompanying drawings, some elements have been illustrated as being enlarged, omitted, or schematically depicted. Furthermore, the size of each element does not accurately reflect its real size. Accordingly, the present disclosure is not restricted by a relative size or interval drawn in the accompanying drawings.

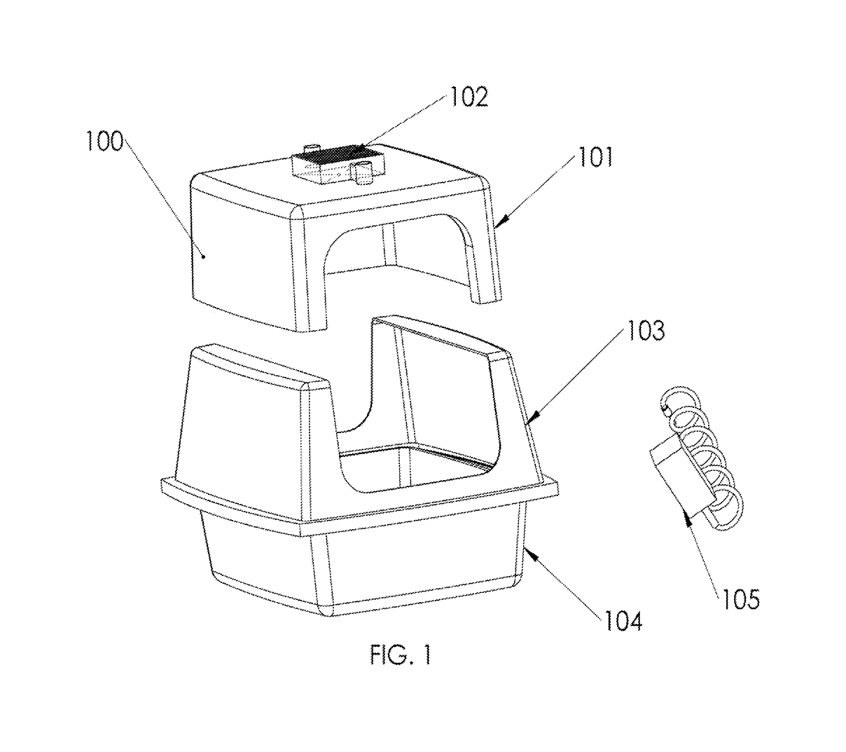

FIG. 1 is a front view of a litter box according to an embodiment of the present disclosure.

Referring to FIG. 1, a litter box 100 includes a hood 101, a fan unit 102, an intermediate side wall 103, a base 104 and power cord 105, but is not limited thereto.

The litter box 100 has a base 104 filled with litter (not illustrated) in which the domesticated animal deposits waste. The intermediate side wall 103 and hood 101 are used to contain litter and/or waste that may kicked free by the domesticated animal. It will be understood that the side wall 103 and hood 101 may be a single unit.

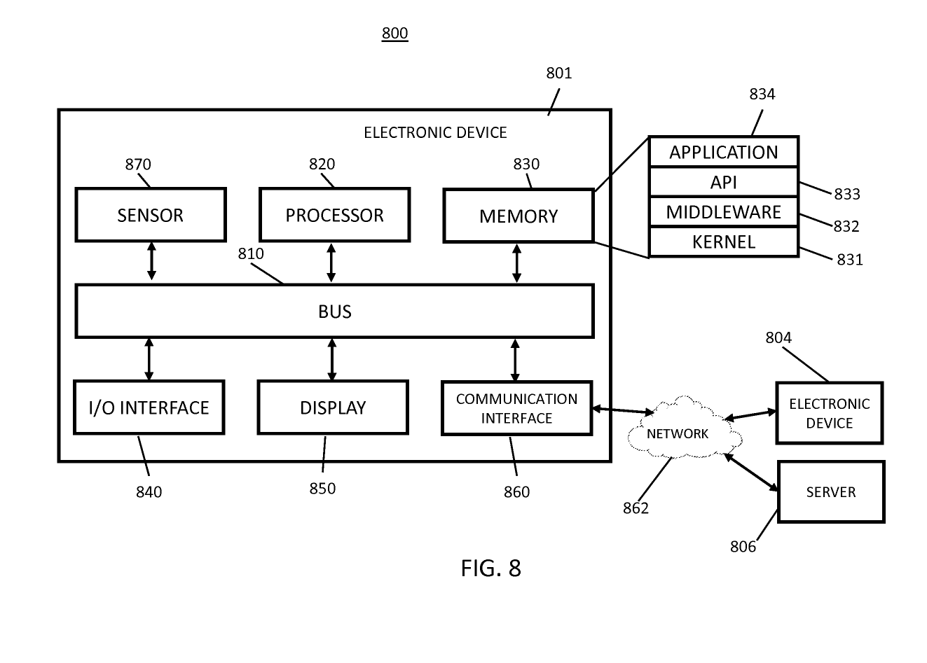

The hood 101 has the fan unit 102 integrated therein. The fan unit 102 has an integrated circuit (IC) (not illustrated), a controller (not illustrated) or a programmed microprocessor (not illustrated) or a network device as illustrated in FIG. 8 that is integrated with a fan (not illustrated) of the fan unit 102 or connected thereto. It will be understood by those of ordinary skill in the art that the IC, the controller or the programmed microprocessor is used to determine when to activate the fan of the fan unit 102. While the fan unit 201 is integrated into the hood 101, it will be understood that the fan unit may be integrated into other constituent pieces of the litter box 100.

In a an embodiment the domesticated animal enters the litter box 100 and a sensor, electrically attached to one of the IC, the controller and the programmed microprocessor, may transmit and indication that the domesticated animal has one of entered and exited the litter box 100. The entrance and exit of the litter box may be used to trigger the fan to expel the smell of the waste from an internal space of the litter box 100. After a predetermined period the one of the IC, the controller and the programmed microprocessor may deactivate the fan.

It will be understood that a point at which the fan is activated is determined by the needs of the domesticated animal. For example, when the domesticated animal is easily spooked, the activation of the fan is delayed until the point at which the domesticated animal exits the litter box 100.

The power cord 105 is a standard alternating current cord for providing power to the fan unit 102, a sensor and the one of the IC, the controller and the programmed microprocessor. It will be understood that the power source may also be a battery (not illustrated) or combination of the power cord 105 and a rechargeable battery (not illustrated).

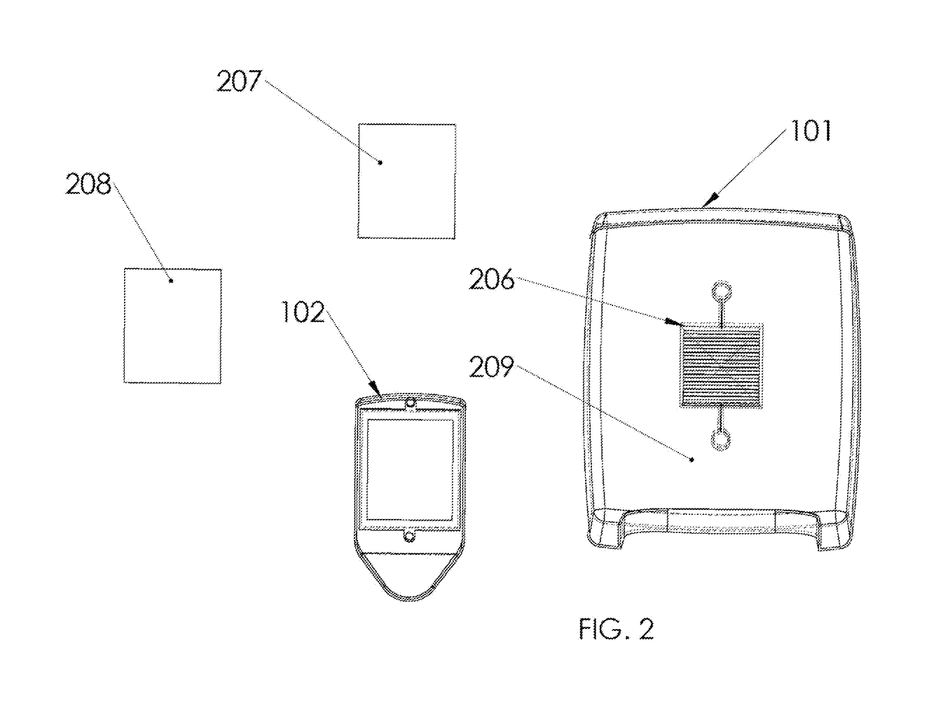

FIG. 2 is a blown out view of a hood of a litter box with a fan unit integrated therein according to an embodiment of the present disclosure.

Referring to FIG. 2, the hood 101 and the fan unit are shown in an exploded state. The hood 101 has an opening 206 for allowing air to be impelled by the fan out of the internal space of the litter box 100. The fan unit 102 further includes a filter 207 and a screen 208. Mounted on a top surface of the hood 101 is a sensor 209. The sensor 209 is hidden by a forward flange portion of the fan unit 102. The sensor 209 may be any of a motion sensor, a proximity sensor, a light sensor and the like. The sensor may also be integrated in an electronic device of FIG. 8, integrated in a forward flange portion of the fan unit 102.

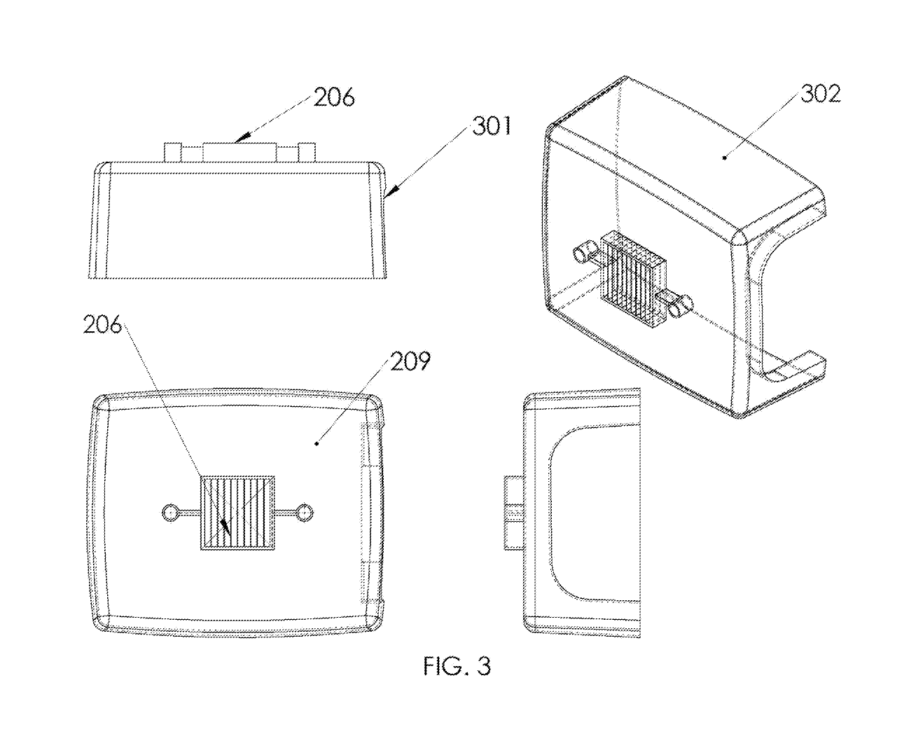

FIG. 3 is a side, front and top view of a hood of a litter box with a fan unit integrated therein according to an embodiment of the present disclosure.

Referring to FIG. 3, a side view 301 of the hood 101 with the opening 206 formed thereon. Likewise, a front view 302 of the hood 102 and a top view 303 of the hood 102 are illustrated.

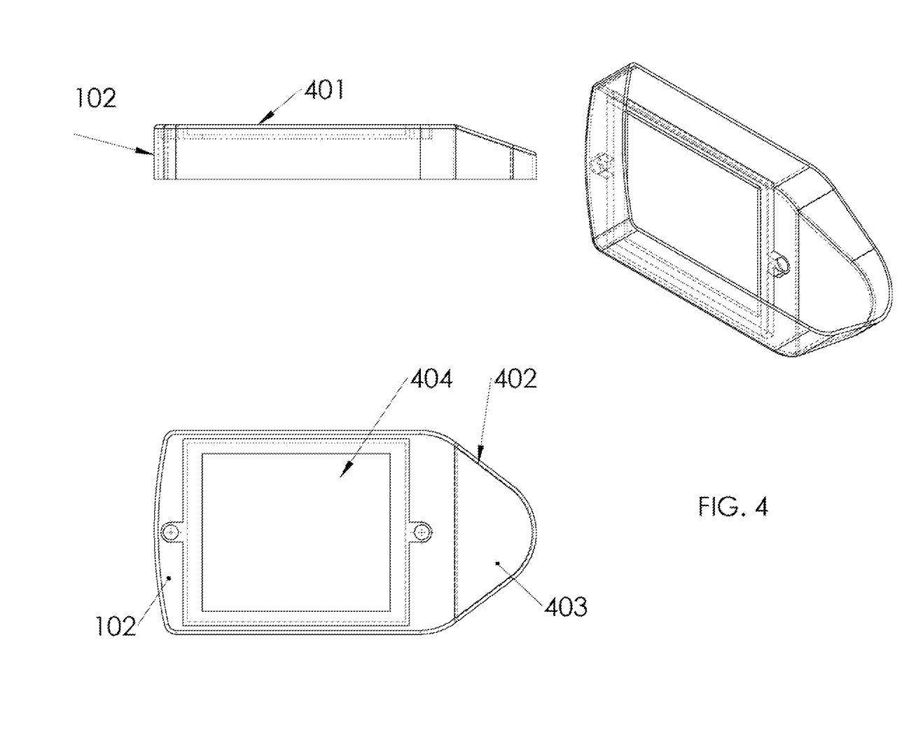

FIG. 4 is a side and top view of a fan unit according to an embodiment of the present disclosure.

Referring to FIG. 4, a side view 401 and top view 402 of the fan unit 102 are illustrated. A height of the fan unit 102 illustrated in side view 401 provides sufficient room for the one of the IC, the controller, the programmed microprocessor and network device.

The fan unit 102 illustrated in top view 402 includes a screen cover 404 and a front flange 403 which covers the sensor 209 and the one of the IC, the controller and the programmed microprocessor.

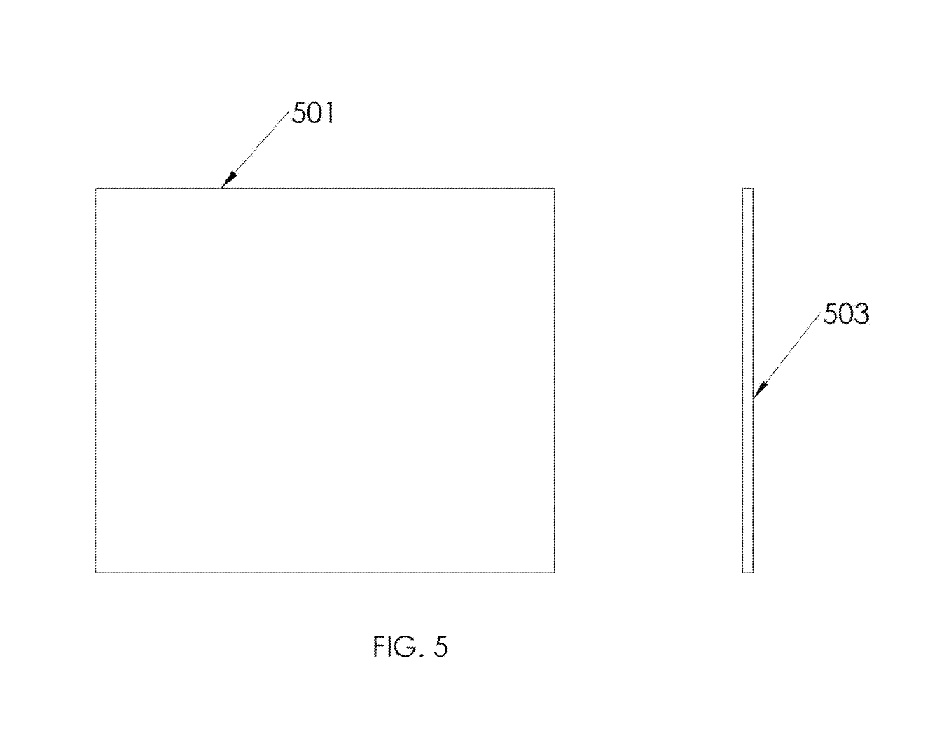

FIG. 5 is a top and side view of a filter according to an embodiment of the present disclosure.

Referring to FIG. 5, a top view 501 and a side view 503 of a filter 207. It will be understood that the filter 207 is configured to be placed between the fan and the screen 208. In an embodiment the filter 209 is a charcoal filter.

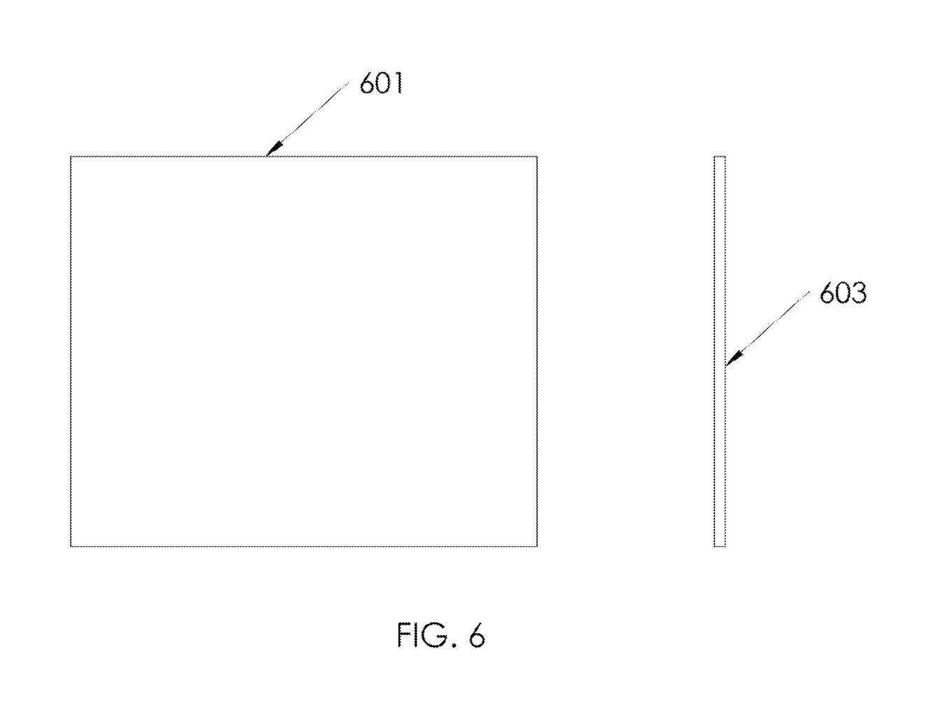

FIG. 6 is a top and side view of a screen according to an embodiment of the present disclosure.

Referring to FIG. 6, a top view 601 and a side view 603 of a filter 208. It will be understood that the screen keeps larger particulates from being impelled out of the interior space of the litter box 100.

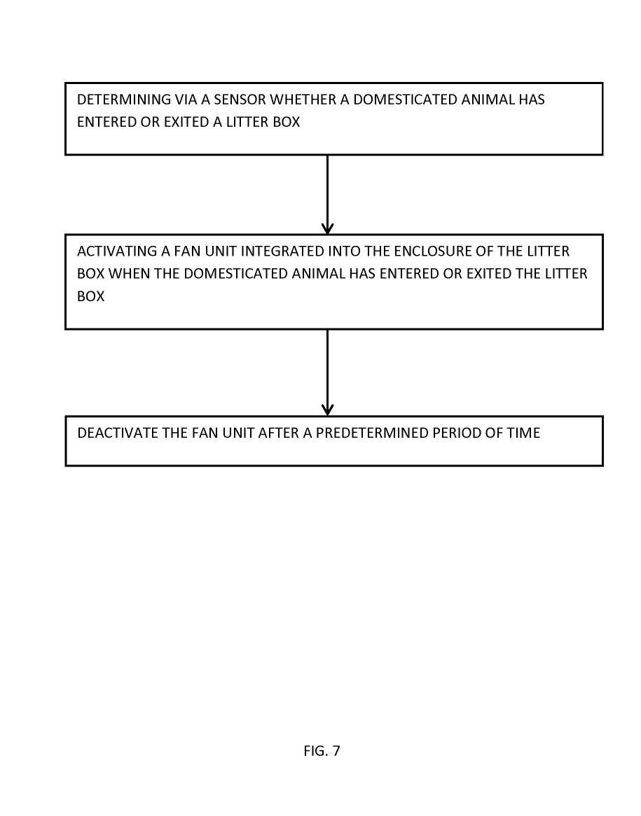

FIG. 7 is a flowchart illustrating a method according to an embodiment of the present disclosure.

Referring to FIG. 7, an operation of 701 of determining that a domesticated animal has entered the litter box 100 of an embodiment of the present disclosure is performed. The determination is made by a sensor 209 activated by the movement of the domesticated animal in the internal space of the litter box 100. The sensor 209 transmits the signal to the one of the IC, the controller and the programmed microprocessor, as are know in the prior art, so that detailed explanation is omitted herein.

In operation 702 the one of the IC, the controller and the programmed microprocessor activates the fan of the fan unit 102 when the domesticated animal one of enters and exists the litter box 100.

In operation 703, the fan of the fan unit 102 is deactivated after a given period of time. That is, the one of the IC, the controller and the programmed microprocessor determines when a predetermined period of time of fan activated has run and cuts power (i.e., deactivates) from the fan of the fan unit 102.

In operation, the method of an embodiment of the present disclosure may further activate the fan of the fan unit 102 periodically to periodically filter the air found in the internal space of the litter box 100.

In operation, the method of an embodiment of the present disclosure may further indicate when the filter 207 requires changing.

In operation, the method of an embodiment of the present disclosure may further indicate the number of times the litter box 100 has been used by an output device (not illustrated). It will be understood that the output device could be any device such a light, a liquid crystal display, a computer, tablet or other hand held device wirelessly connected to the one of the IC, the controller and the programmed microprocessor.

FIG. 8 illustrates a network environment including an electronic device integrated into a litter box or attached thereto according to various embodiments of the present disclosure.

Referring to FIG. 8, a network environment 800 includes an electronic device 801. The electronic device 801 may include a bus 810, a processor 820, a memory 830, an Input/Output (I/O) interface 840, a display 850, a communication interface 860, a sensor 870, and/or the like.

The bus 810 may be circuitry that connect the foregoing components and allow communication between the foregoing components. For example, the bus 810 may connect components of the electronic device 801 so as to allow control messages and/or other information to be communicated between the connected components.

The processor 820 may, for example, receive instructions from other components (e.g., the memory 830, the I/O interface 840, the display 850, the communication interface 860, the sensor 870, and/or the like), interpret the received instructions, and execute computation or data processing according to the interpreted instructions.

The memory 830 may, for example, store instructions and/or data that are received from, and/or generated by, other components (e.g., the memory 830, the I/O interface 840, the display 850, the communication interface 860, the sensor 870, and/or the like). For example, the memory 830 may include programming modules such as a kernel 831, a middleware 832, an Application Programming Interface (API) 833, an application 834, and/or the like. Each of the foregoing programming modules may include a combination of at least two of software, firmware, or hardware.

The kernel 831 may control or manage system resources (e.g., the bus 810, the processor 820, the memory 830, and/or the like) that may be used in executing operations or functions implemented in other programming modules such as, for example, the middleware 832, the API 833, the application 834, and/or the like. The kernel 831 may provide an interface for allowing or otherwise facilitating the middleware 832, the API 833, the application 834, and/or the like, to access individual components of electronic device 801.

The middleware 832 may be a medium through which the kernel 831 may communicate with the API 833, the application 834, and/or the like to send and receive data. The middleware 832 may control (e.g., scheduling, load balancing, and/or the like) work requests by one or more applications 834. For example, the middleware 832 may control work requests by one or more applications 834 by assigning priorities for using system resources (e.g., the bus 810, the processor 820, the memory 830, and/or the like) of electronic device 801 to the one or more applications 834.

The API 833 may be an interface that may control functions that the application 834 may provide at the kernel 831, the middleware 832, and/or the like. For example, the API 833 may include at least an interface or a function (e.g., command) for file control, window control, video processing, character control, and/or the like.

According to various embodiments of the present disclosure, the application 834 may include a Short Message Service (SMS) application, a Multimedia Messaging Service (MMS) application, an email application, a calendar application, an alarm application, a health care application (e.g., an exercise amount application, a blood sugar level measuring application, and/or the like), an environmental information application (e.g., an application that may provide atmospheric pressure, humidity, temperature information, and/or the like), an instant messaging application, a call application, an internet browsing application, a gaming application, a media playback application, an image/video capture application, a file management application, and/or the like. In addition to or as an alternative to, the application 834 may be an application that is associated with information exchange between the electronic device 801 and an external electronic device (e.g., electronic device 804). As an example, the application 834 that is associated with the information exchange may include a notification relay application that may provide the external electronic device with a certain type of information, a device management application that may manage the external electronic device, and/or the like.

As an example, the notification relay application may include a functionality that provides notification generated by other applications at electronic device 801 (e.g., the SMS/MMS application, the email application, the health care application, the environmental information application, the instant messaging application, the call application, the internet browsing application, the gaming application, the media playback application, the image/video capture application, the file management application, and/or the like) to an external electronic device (e.g., the electronic device 804). In addition to or as an alternative to, the notification relay application may provide, for example, receive notification from an external electronic device (e.g., the electronic device 804), and may provide the notification to a user.

As an example, the device management application may manage enabling or disabling of functions associated with least a portion of an external electronic device (e.g., the external electronic device itself, or one or more components of the external electronic device) in communication with electronic device 801, controlling of brightness (or resolution) of a display of the external electronic device, an application operated at, or a service (e.g., a voice call service, a messaging service, and/or the like) provided by, the external electronic device, and/or the like.

According to various embodiments of the present disclosure, as an example, the application 834 may include one or more applications that are determined according to a property (e.g., type of electronic device, and/or the like) of the external electronic device (e.g., the electronic device 804). For example, if the external electronic device is an mp3 player, the application 834 may include one or more applications related to music playback. As another example, if the external electronic device is a mobile medical device, the application 834 may be a health care-related application. According to various embodiments of the present disclosure, the application 834 may include at least one of an application that is preloaded at the electronic device 801, an application that is received from an external electronic device (e.g., the electronic device 804, a server 806, and/or the like), and/or the like.

The I/O interface 840 may, for example, receive instruction and/or data from a user. The I/O interface 840 may send the instruction and/or the data, via the bus 810, to the processor 820, the memory 830, the communication interface 860, the sensor 870, and/or the like. For example, the I/O interface 840 may provide data associated with user input received via a touch screen to the processor 820. The I/O interface 840 may, for example, output instructions and/or data received via the bus 810 from the processor 820, the memory 830, the communication interface 860, the sensor 870, and/or the like, via an I/O device (e.g., a speaker, a display, and/or the like). For example, the I/O interface 840 may output voice data (e.g., processed using the processor 820) via a speaker.

The display 850 may display various types of information (e.g., multimedia, text data, and/or the like) to the user. As an example, the display 850 may display a Graphical User Interface (GUI) with which a user may interact with the electronic device 801.

The communication interface 860 may provide communication between electronic device 801 and one or more external electronic devices (e.g., the electronic device 804, the server 806, and/or the like). For example, the communication interface 860 may communicate with the external electronic device by establishing a connection with a network 862 using wireless or wired communication. As an example, wireless communication with which the communication interface 860 may communicate may be at least one of, Wi-Fi, Bluetooth, Near Field Communication (NFC), Global Positioning System (GPS), cellular communication (e.g., Long Term Evolution (LTE), LTE Advanced (LTE-A), Code Division Multiple Access (CDMA), Wideband-CDMA (WDCMA), Universal Mobile Telecommunications System (UMTS), Wireless Broadband (WiBro), Global System for Mobile Communications (GSM), and/or the like), Infrared Data Association (IrDA) technology, and/or the like. As an example, wired communication with which the communication interface 860 may communicate may be at least one of, for example, Universal Serial Bus (USB), High Definition Multimedia Interface (HDMI), Recommended Standard 232 (RS-232), Plain Old Telephone Service (POTS), Ethernet, and/or the like.

According to various embodiments of the present disclosure, the network 862 may be a telecommunications network. As an example, the telecommunications network may include at least one of a computer network, the Internet, the Internet of Things, a telephone network, and/or the like. According to various embodiments of the present disclosure, a protocol (e.g., a transport layer protocol, a data link layer protocol, a physical layer protocol, and/or the like) for communicating between electronic device 801 and an external electronic device may be supported by, for example, at least one of the application 834, the API 833, the middleware 832, the kernel 831, the communication interface 860, and/or the like.

The sensor 870 may, for example, be one of a temperature sensor, a magentic sensor, an acceloration sensor, a weight sensor, a proximity sensor, a light sensor , a camera and the like. It will be understood that the electronic device 801 vis the processor 820 is programmed, to detect via the sensor 870, the presence of a domesticated animal and either activate a fan of the fan unit 102 when the domesticated animal has either entered or exited the litter box. The processor 820 is further programmed, to deactivate the fan after a given period of time. The sensor 870 may also determine the condition of the litter in the box and indicate via the display 850 or by transmission to another electronic device 804 or server 806 or the condition of the filter 207 based upon the number of times the fan is activated or other indications know to those of ordinary skill in the art.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A litter box aerator apparatus, the apparatus comprising:
a base portion containing litter;
a hood portion configured to enclose the litter box;
a fan unit integrated within the hood portion;
a sensor configured to determine when a domesticated animal is present in an internal space of the litter box; and
a controller configured to activate the fan of the fan unit when the domesticated animal one of enters and exist the internal space of the litter box.

2. The apparatus of claim 1, wherein the fan unit comprises a fan, a filter and a screen.

3. The apparatus of claim 2, wherein the controller is further configured to deactivate the fan of the fan unit after a predetermined period of time.

4. The apparatus of claim 1, wherein the controller is further configured to indicate the condition of the litter.

5. The apparatus of claim 4, wherein the controller is further configured to display the indication on a display.

6. The apparatus of claim 4, wherein the controller is further configured to transmit the indication to another device.

7. The apparatus of claim 1, wherein the controller is further configured to indicate the condition of the filter.

8. The apparatus of claim 7, wherein the controller is further configured to display the indication on a display.

9. The apparatus of claim 7, wherein the controller is further configured to transmit the indication to another device.

10. A method of aerating a litter box, the method comprising:
determining, via a sensor, whether a domesticated animal has one of entered and exited an internal space of an enclosure of the litter box; and
activating a fan unit integrated into the enclosure of the litter box based upon the determination of whether the domesticated animal has one of entered and exited the internal space of an enclosure of the litter box.

11. The method of claim 10, wherein the fan unit comprises a fan, a filter and a screen.

12. The apparatus of claim 11, further comprising deactivating the fan of the fan unit after a predetermined period of time.

13. The method of claim 10, further comprising indicating the condition of the litter.

14. The method of claim 13, further comprising displaying the indication on a display.

15. The method of claim 13, further comprising transmitting the indication to another device.

16. The method of claim 10, further comprising indicating the condition of the filter.

17. The method of claim 16, further comprising displaying the indication on a display.

18. The method of claim 16, further comprising transmitting the indication to another device.

19. A litter box, comprising:
an enclosure configured to hold and prevent litter and other debris from being kicked out of the litter box;
a fan configured to propel fumes and particulates out of the litter box;
an electronic device configured to:
determine a presence of a domesticated animal within the enclosure,
activate the fan based on the determination of the presence of the domesticated animal, and
deactivate the fan after a period of time.

20. The litter box of claim 20, wherein the activation of the fan based on the determination of the presence of the domesticated animal occurs at one of the domesticated animal entering the enclosure or exiting the enclosure.
